(19) United States
(12) Patent Application Publication
(10) Pub. No.: US 2007/0042495 A1
(43) Pub. Date: Feb. 22, 2007

(54) Method of controlling injection of a reducing agent in an engine emissions control system

(75) Inventors: Zornitza Pavlova-MacKinnon, Farmington Hills, MI (US); Min Sun, Windsor (CA)

Correspondence Address: BROOKS KUSHMAN P.C., 1000 TOWN CENTER, TWENTY-SECOND FLOOR, SOUTHFIELD, MI, 48075, US

(73) Assignee: Detroit Diesel Corporation, Detroit, MI (US)

(21) Appl. No.: 11/209,131

(22) Filed: Aug. 22, 2005

(51) Int. Cl. G01N 35/08

(52) U.S. Cl. 436/55

(57) ABSTRACT

A method of controlling injection of a reducing agent in an engine emissions control system. The method includes determining a predicted amount of reducing agent in a selective catalytic reduction system, comparing the predicted amount to a target amount, injecting reducing agent when the predicted amount is less than the target amount, and inhibiting injection of reducing agent when the predicted amount is not less than the target amount.

### BACKGROUND OF THE INVENTION

1. Field of the Invention

The present invention relates to a method of controlling injection of a reducing agent in an engine emissions control system to reduce NOₓ emissions.

2. Background Art

Internal combustion engines produce exhaust gases that include undesirable combustion byproducts, such as oxides of nitrogen (NOₓ). To reduce NOₓ emissions, emission control systems are employed. Such emission control systems may provide fluids, such as ammonia or urea, to a catalyst. These fluids and the exhaust gases react with the catalyst to help reduce emissions.

Previously, the amount of reducing agent stored in the catalyst could not be directly measured with a sensor without sacrificing accuracy and/or sensor resolution. As a result, an inappropriate amount of reducing agent could be provided to the catalyst. Providing an insufficient amount of reducing agent results in ineffective NOₓ reduction while an excess amount of reducing agent results in waste.

### SUMMARY OF THE INVENTION

In at least one embodiment of the present invention, a method of controlling injection of a reducing agent in an engine emissions control system is provided. The engine emissions control system includes an engine adapted to provide an exhaust gas, a selective catalytic reduction system, and a reducing agent injection system adapted to provide reducing agent to the selective catalytic reduction system.

The method includes the steps of determining a predicted amount of reducing agent in the selective catalytic reduction system, comparing the predicted amount to a target amount, injecting reducing agent when the predicted amount is less than the target amount, and inhibiting injection of reducing agent when the predicted amount is not less than the target amount.

In at least one other embodiment of the present invention, a method for controlling injection of a reducing agent in an engine emissions control system is provided. The method includes the steps of determining a predicted amount of reducing agent in the selective catalytic reduction system, comparing the predicted amount to a target amount, inhibiting injection of reducing agent when the predicted amount is not less than the target amount, comparing the predicted amount to a threshold value when the predicted amount is less than the target amount, injecting reducing agent at a first rate when the predicted amount is less than the threshold value, and injecting reducing agent at a second rate when the predicted amount is not less than the threshold value.

### BRIEF DESCRIPTION OF THE DRAWINGS

FIG. 1 is a schematic of an engine system having a reducing agent injection system.

FIG. 2 is a flowchart of an embodiment of a method of controlling injection of a reducing agent.

FIG. 3 is a flowchart of another embodiment of the method of controlling injection of the reducing agent.

### DETAILED DESCRIPTION

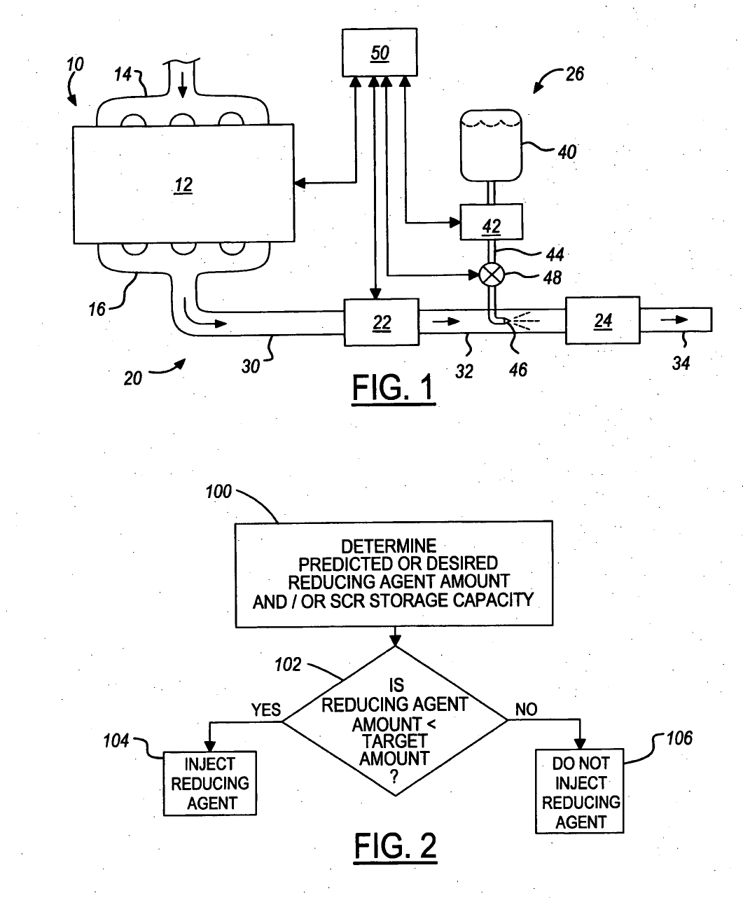

Referring to FIG. 1, a schematic of an engine system 10 is shown. As will be appreciated by those of ordinary skill in the art, the engine system 10 may be used in a wide variety of equipment such as trucks, construction equipment, marine vessels and stationary generators. Moreover, it should be noted that the present invention is not limited to a particular type of engine or fuel.

The engine system 10 includes an engine 12. The engine 12 may be an internal combustion engine and may have a plurality of cylinders. In the embodiment shown in FIG. 1, the engine 12 includes an intake manifold 14 and an exhaust manifold 16. The intake manifold 14 provides gases, such as air and/or exhaust gas, to the engine 12 for combustion. The exhaust manifold 16 receives gases from the engine 12 after combustion. The flow of gases in the engine system 10 is generally denoted by freestanding arrows in FIG. 1.

In a vehicular application, the engine 12 may be connected to a transmission that is adapted to drive one or more vehicle traction wheels. For example, an output shaft of the transmission may be connected to a driveshaft. The driveshaft may be connected to a differential that is connected to a pair of axles that are each connected to a vehicle wheel. Engine torque may be transmitted through the transmission, differential, and one or more axles to turn the vehicle traction wheels.

The engine system 10 may also include an emissions control system 20. The emissions control system 20 is adapted to remove pollutants and/or particulates from engine exhaust gases. These pollutants and/or particulates may be byproducts of combustion that occurs in the engine 12. The emissions control system 20 is configured to receive exhaust gases from the exhaust manifold 16. The emissions control system 20 may have any suitable configuration. In the exemplary embodiment shown in FIG. 1, the emissions control system 20 includes a particulate filter 22, a selective catalytic reduction (SCR) system 24, and a reducing agent injection system 26.

The particulate filter 22, if provided, may be adapted to remove particulate matter from the exhaust gases. The particulate filter 22 may be of any suitable type and have any suitable configuration. In addition, the particulate filter 22 may be provided in any suitable location, such as upstream and/or downstream from the selective catalytic reduction system 24. In the embodiment shown, the particulate filter 22 has an inlet coupled to the exhaust manifold 16 by an intake pipe 30 and is disposed upstream of the selective catalytic reduction system 24.

The selective catalytic reduction system 24 facilitates the removal of oxides of nitrogen (NOₓ) from the exhaust gases. The selective catalytic reduction system may be of any suitable type and may have any suitable configuration. For example, the selective catalytic reduction system 24 may be configured as a containment vessel having a plurality of plates disposed therein. The plates may have a plurality of apertures that facilitate the flow of exhaust gases. In addition, the plates and/or internal surface of the containment vessel may include a catalyst coating or catalytic surface that facilitates a reaction that converts or removes pollutants, such as NOₓ, from the exhaust gas stream under certain conditions. Moreover, the selective catalytic reduction system 24 may be configured to contain or store a volume of reducing agent that facilitates the reaction and may be insulated to reduce heat loss. In the embodiment shown in FIG. 1, the selective catalytic reduction system 24 includes an inlet and an outlet. The inlet is coupled to the particulate filter 22 by a connecting pipe 32. The outlet may be coupled to an outlet pipe 34 that releases gases to the surrounding environment or may provide gases to one or more mufflers and/or a particulate filter.

The reducing agent injection system 26 is adapted to provide a reducing agent, such as ammonia, urea, or aqueous solutions thereof, to one or more components of the emissions control system 20. In the embodiment shown, the reducing agent injection system 26 includes a storage tank 40, dosing unit or pump 42, and an injector tube 44.

The storage tank 40 is adapted to hold a predetermined volume of reducing agent. The storage tank 40 may have any suitable configuration and may be disposed in any suitable location. In addition, the storage tank 40 may be heated to keep the reducing agent at a suitable temperature, such as above −10° C.

The pump 42 is adapted to provide a pressurized amount of reducing agent to the emissions control system 20. The pump 42 may be of any suitable type. In addition, the pump 42 may be disposed in any suitable location, such as inside or outside the storage tank 40. Moreover, the pump 42 may be configured to provide fluid at multiple pressures and/or flow rates. In the embodiment shown, the pump 42 has an intake port connected to the storage tank 40 and an outlet port coupled to the injector tube 44. Optionally, the pump 42 may incorporate its own control module or control unit.

The injector tube 44 is adapted to provide pressurized reducing agent to at least one component of the emissions control system 20. The injector tube 44 may include a nozzle 46 disposed at an end. The nozzle 46 may be configured to spray reducing agent into the exhaust gas stream in a predetermined configuration. The injector tube 44 and nozzle 46 may be disposed in any suitable location. In the embodiment shown, at least a portion of the nozzle 46 is located in the connecting tube 32 and is generally directed downstream toward the selective catalytic reduction system 24. In addition, the injector tube 44 and nozzle 46 may be disposed upstream of a bend in the connecting tube 32 and or at a predetermined distance from the selective catalytic reduction system 24 to facilitate mixing of the reducing agent with the exhaust gases.

Optionally, the reducing agent injection system 26 may include one or more flow control valves 48 adapted to move between an open position and a closed position. The flow control valve 48 may be disposed in any suitable location, such as in the injector tube 44 and upstream or downstream from the pump 42. The flow control valve 48 permits reducing agent to flow when in the open position and inhibits flow in the closed position. In addition, the flow control valve 48 may be set at any suitable intermediate position between the open and closed positions to reduce the flow rate of the reducing agent as compared to the open position.

The engine system 10 may also include one or more control modules 50. The control module 50 may be used to monitor and control various aspects of the engine system 10. For example, the control module 50 may communicate with the engine 12, particulate filter 22, pump 42, and/or flow control valve 48 to monitor and control their operation and performance.

The control module 50 also processes inputs from various components. These components may include an intake manifold pressure sensor and an intake manifold temperature sensor. The control module 50 may also be connected to a temperature sensor, a humidity sensor, and a mass flow sensor. The temperature sensor and the humidity sensor may be disposed in any suitable location, such as in the air inlet conduit. Optionally, the temperature and humidity sensors may be combined into a single sensor or sensor module. The mass flow sensor may be disposed in conduit to provide a signal indicative of the mass flow rate of the recirculated exhaust gas.

The temperature sensors may be of any suitable type, such as a thermistor or thermocouple. Likewise, the pressure sensor may be of any suitable type, such as a pressure switch.

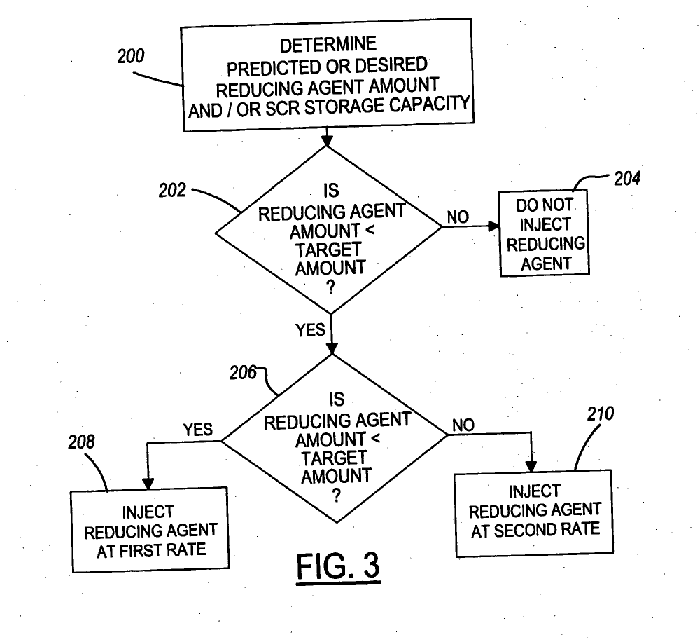

Referring to FIGS. 2 and 3, flowcharts of exemplary methods of controlling reducing agent injection is shown. As will be appreciated by one of ordinary skill in the art, the flowchart represents control logic which may be implemented or affected in hardware, software, or a combination of hardware and software. For example, the various functions may be effected by a programmed microprocessor, such as that included in the DDEC controller manufactured by Detroit Diesel Corporation, Detroit, Mich. The control logic may be implemented using any of a number of known programming and processing techniques or strategies and is not limited to the order or sequence illustrated. For instance, interrupt or event-driven processing is typically employed in real-time control applications, such as control of an engine or vehicle rather than a purely sequential strategy as illustrated. Likewise, parallel processing, multi-tasking, or multi-threaded systems and methods may be used to accomplish the objectives, features, and advantages of the present invention.

The invention is independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the features and advantages of the present invention. The illustrated functions may be modified, or in some cases omitted, without departing from the spirit or scope of the present invention.

In at least one embodiment of the present invention, the method may be executed by the control module 50 and may be implemented as a closed loop control system. Moreover, the method may be enabled or disabled based the operating state of the engine system 10 and/or current environmental conditions. For example, the execution of the method may be disabled if the temperature of the exhaust gases or selective catalytic reduction system 24 is below a threshold temperature.

The method of the present invention permits reducing agent levels in the selective catalytic reduction system to be assessed and controlled without directly detecting the amount of reducing agent inside the SCR and/or without detecting or measuring the amount of NOₓ reduction in the exhaust gas stream. As such, the present invention may act as a “virtual sensor” that provides reducing agent assessments under steady state and transient operating conditions.

The virtual sensor aspects of the present invention will now be described in more detail. As previously discussed, the selective catalytic reduction system (SCR) facilitates the removal of oxides of nitrogen (NOₓ) from exhaust gases. The maximum amount of reducing agent that can be stored in the SCR is dynamic. More specifically, the maximum reducing agent storage capacity (in moles or units of mass) in the SCR at a given moment in time is a function of various factors, including catalyst temperature, exhaust gas volumetric flow, and catalyst attributes (e.g., catalyst formulation and geometry). Thus, the percent of reducing agent storage capacity utilized may be expressed by dividing the amount of reducing agent in the SCR by the maximum reducing agent storage capacity in the SCR. As previously discussed, the actual amount of ammonia in the catalyst can be difficult to measure with sufficient accuracy. Thus, the amount (or percentage) of reducing agent storage capacity utilized (designated “Storage Utilized”) may be determined by dividing a target amount of reducing agent in the SCR (designated “Target”) by the maximum reducing agent storage capacity in the SCR (designated “Max_Capacity”) as shown in the following expression:

$$Storage Utilized = \frac{Target}{Max\_Capacity}$$

Referring to FIG. 2, a first embodiment of the method is shown. At 100, the method begins by predicting the amount of reducing agent present in the selective catalytic reduction system. A reducing agent like urea or ammonia may be employed. More specifically, under appropriate conditions urea [(NH₂)₂CO] is converted into ammonia [NH₃] in accordance with the following reactions:
(NH₂)₂CO→HNCO+NH₃
HNCO+H₂O→CO₂+NH₃

Ammonia may be used with a catalyst to facilitate removal of NOₓ from combustion gases in accordance with the following reactions:
4NO+4NH₃+O₂→4N₂+6H₂O
2NO₂+4NH₃+O₂→3N₂+6H₂O

At 102, the predicted amount of reducing agent is compared to a target amount. The target amount may be a constant or may vary depending on

At 102, the predicted amount of reducing agent is compared to a target amount. The target amount may be a constant or may vary depending on the operating conditions or operating state of the engine system 10. Moreover, the target amount may be set no greater than the “full” or predicted maximum reactive capacity of the selective catalytic reduction system 24. For example, the target amount may be set from 50% to 100% of a “full” or maximum capacity amount. In one embodiment, the target amount is set at approximately 90%. Setting the target amount at a level less than the full state helps prevent excess reducing agent from being provided to the selective catalytic reduction system 24 that would result in waste. In addition, setting the target amount at a level less than the full state helps inhibit waste in the event of changed operating or environmental conditions. If the predicted amount of reducing agent is less than the target amount, then the method continues at block 104. If the predicted amount of reducing agent is not less than the target amount, then the method continues at block 106.

At 104, reducing agent is injected or provided to the emissions control system 20. Reducing agent may be provided by turning on or continuing operation of the pump 42. In addition, any flow control valves in the reducing agent injection system 26 may be actuated to an open position to facilitate the flow of reducing agent. Operation of the pump 42 and any flow control valves 48 may be controlled by the control module 50. Moreover, the pump 42 may provide reducing agent continuously or may provide reducing agent at a predetermined flow rate or for a predetermined amount of time.

At 106, reducing agent injection is inhibited. Reducing agent injection may be inhibited by stopping operation of the pump 42, if the pump is currently operating, or by preventing the pump 42 from being turned on. Optionally, a flow control valve disposed in the reducing agent injection control system 26 may be actuated to a closed position to inhibit flow.

Referring to FIG. 3, an alternate embodiment of the present invention is shown. In this embodiment, reducing agent is provided in a more sophisticated manner as will be described below in more detail.

At 200, the method begins by predicting the amount of reducing agent present in the selective catalytic reduction system as described above in accordance with block 100.

At 202, the predicted amount of reducing agent is compared to a target amount as described above in accordance with block 102. If the predicted amount of reducing agent is not less than the target amount, then the method continues at block 204. If the predicted amount of reducing agent is less than the target amount, then the method continues at block 206.

At 204, reducing agent is injected or provided to the emissions control system 20 as described above in accordance with block 106.

At 206, the predicted amount of reducing agent is compared to a threshold value. The threshold value may be a constant or may vary depending on the operating conditions or operating state of the engine system 10. Moreover, the threshold value is set at a level less than the target amount. For example, the threshold value may be set from 80% to 10% of a full amount. In one embodiment, the threshold value is set at approximately 50%. Setting the threshold value at a level less than the target amount permits different reducing agent flow rates to be employed when supplying reducing agent to the selective catalytic reduction system 24. If the predicted amount of reducing agent is less than the threshold value, then the method continues at block 208. If the predicted amount of reducing agent is not less than the threshold value, then the method continues at block 210.

At 208, reducing agent is injected or provided to the emissions control system 20 at a first rate. Similar to block 104, reducing agent may be provided by controlling operation of the pump 42 and/or any flow control valve 48. The first rate may be a constant or variable amount that is greater than a second rate described below in accordance with block 210. Since the predicted level of reducing agent in the selective catalytic reduction system 24 is less than the threshold value and the target amount, reducing agent may be provided at a faster rate to more rapidly replenish or fill the selective catalytic reduction system 24, thereby reducing emissions. In addition, the first or faster rate may be employed since there is a low probability that an excess of reducing agent will be provided to or be present in the selective catalytic reduction system 24 in the event of changes in operating or environmental conditions.

At 210, reducing agent is injected or provided to the emission control system 20 at a second rate that is less than the first rate. Similar to block 104, reducing agent may be provided by controlling operation of the pump 42 and/or flow control valves 48. Since the predicted level of reducing agent in the selective catalytic reduction system 24 is greater than the threshold value but less than the target amount, reducing agent may be provided, but at a slower rate to provide improved sensitivity and responsiveness when the target amount is approached. As such, the method reduces the likelihood that an excess of reducing agent will be provided to or be present in the selective catalytic reduction system 24 in the event of changes in operating or environmental conditions.

The present invention also contemplates embodiments that incorporate more than two rates for providing reducing agent to one or more components of an emissions control system 20. For example, any suitable number of additional threshold values or ranges of threshold values may be used to define boundary conditions for multiple reducing agent injection flow rates.

Various embodiments of the present invention may help reduce reducing agent waste, improve responsiveness to changes in operating conditions, and/or help reduce NOₓ emissions. Moreover, the present invention may help improve NOₓ conversion efficiency at cold start conditions when the catalyst is not fully heated.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of controlling injection of a reducing agent in an engine emissions control system, the engine emissions control system including an engine adapted to provide an exhaust gas, a selective catalytic reduction system, and a reducing agent injection system adapted to provide reducing agent to the selective catalytic reduction system, the method comprising:
determining a predicted amount of reducing agent stored in the selective catalytic reduction system;
comparing the predicted amount to a target amount;
injecting reducing agent when the predicted amount is less than the target amount; and
inhibiting injection of reducing agent when the predicted amount is not less than the target amount.

2. The method of claim 1 wherein the target amount is in a range of 50% to 100% of a maximum reducing agent storage capacity of the selective catalytic reduction system.

3. The method of claim 1 wherein the target amount is in a range of 90% to 95% of a maximum reducing agent storage capacity of the selective catalytic reduction system.

4. The method of claim 1 wherein the reducing agent injection system further comprises a pump and the step of inhibiting injection further comprises inhibiting operation of the pump.

5. The method of claim 1 wherein the reducing agent injection system further comprises a flow control valve and the step of inhibiting injection further comprises actuating the flow control valve to a closed position

6. A method of controlling injection of a reducing agent in an engine emissions control system, the engine emissions control system including an engine adapted to provide an exhaust gas, a selective catalytic reduction system, and a reducing agent injection system adapted to provide reducing agent to the selective catalytic reduction system, the method comprising:
determining a predicted amount of reducing agent in the selective catalytic reduction system;
comparing the predicted amount to a target amount;
inhibiting injection of reducing agent when the predicted amount is not less than the target amount;
comparing the predicted amount to a threshold value when the predicted amount is less than the target amount;
injecting reducing agent at a first rate when the predicted amount is less than the threshold value; and
injecting reducing agent at a second rate when the predicted amount is not less than the threshold value.

7. The method of claim 6 wherein the second rate is less than the first rate to inhibit providing more reducing agent to the selective catalytic reduction system that can be reacted with oxides of nitrogen present in the exhaust gas.

8. The method of claim 6 wherein the first rate is a variable amount.

9. The method of claim 6 wherein the threshold value is in a range of 10% to 80% of a maximum reducing agent storage capacity of the selective catalytic reduction system.

10. The method of claim 6 wherein the threshold value is in a range of 50% to 10% of a maximum reducing agent storage capacity of the selective catalytic reduction system.

11. A method of controlling injection of a reducing agent in an engine emissions control system, the engine emissions control system including an engine adapted to provide an exhaust gas, a selective catalytic reduction system, and a reducing agent injection system adapted to provide reducing agent to the selective catalytic reduction system, the method comprising:
determining a maximum reducing agent storage capacity value of the selective catalytic reduction system;
determining a desired amount of reducing agent to be stored in the selective catalytic reduction system;
determining a ratio value based on the desired amount and the maximum reducing agent storage capacity value; and
injecting reducing agent when the ratio value is less than a target amount.

12. The method of claim 11 further comprising the step of inhibiting injection of reducing agent when the ratio value is not less than the target amount.

13. The method of claim 11 wherein the ratio value is determined by dividing the desired amount by the maximum reducing agent storage capacity value.

14. The method of claim 11 wherein the maximum storage capacity is a function of a catalyst temperature, exhaust gas volumetric flow, catalyst formulation, and catalyst geometry.

15. The method of claim 11 wherein the ratio value is determined without measuring NOₓ reduction in exhaust gas exiting the selective catalytic reduction system.

16. The method of claim 11 further comprising the steps of comparing the ratio value to a threshold value when the ratio value is less than a target amount, injecting reducing agent at a first rate when the ratio value is less than the threshold value, and injecting reducing agent at a second rate when the ratio value is not less than the threshold value.
